(19) United States
(12) Patent Application Publication
(10) Pub. No.: US 2002/0063923 A1
(43) Pub. Date: May 30, 2002

(54) System and method for improving optical signal-to-noise ratio measurement range of a monitoring device

(75) Inventors: David A. Coppeta, Atkinson, NH (US); David Goodwin, Concord, NH (US)

Correspondence Address: Gary B. Solomon Esq., Jenkens & Gilchrist, P.C., 1445 Ross Avenue, Suite 3200, Dallas, TX, 75202-2799, US

(73) Assignee: LIGHTCHIP, INC.

(21) Appl. No.: 09/884,851

(22) Filed: Jun. 18, 2001

Related U.S. Application Data
(60) Provisional application No. 60/220,951, filed on Jul. 26, 2000.
(60) Provisional application No. 60/208,483, filed on Jun. 2, 2000.

(51) Int. Cl. H04B 10/08; H04J 14/02

(52) U.S. Cl. 359/124; 359/110

(57) ABSTRACT

A method and device for improving a signal-to-noise ratio measurement range of a monitoring device operating on a fiber optic network. The method includes receiving a wavelength division multiplexed optical signal including a plurality of optical signals centered at different wavelengths within a range of wavelengths. The wavelength division multiplexed optical signal is dispersed to form a discrete power spectrum. The discrete power spectrum is measured, and data representing the measured optical signals is generated. The measured optical signals include a point spread function response of a pixelated optical detector. A deconvolution operation is performed on the generated data to create an estimate that is more representative of the power spectrum by compensating for the point spread function of the pixelated optical detector.

### BACKGROUND OF THE PRESENT INVENTION

1. Field of the Invention

The present invention relates generally to monitoring optical signals, and more specifically, a method and system for improving an optical signal-to-noise ratio measurement range relating to measurements made by a monitoring system on a fiber optic network.

2. Description of the Related Art

The telecommunications industry has grown significantly in recent years due to developments in technology, including the Internet, e-mail, cellular telephones, and fax machines. These technologies have become affordable to the average consumer such that the volume of traffic on telecommunications networks has grown significantly. Furthermore, as the Internet has evolved, more sophisticated applications have increased data volume being communicated across the telecommunications networks.

To accommodate the increased data volume, the infrastructure of the telecommunications networks has been evolving to increase the bandwidth of the telecommunications networks. Fiber optic networks that carry wavelength division multiplexed optical signals provide for significantly increased data channels for the high volume of traffic. One component of the fiber optic network is an optical performance monitor (OPM), which is a spectrometer capable of measuring power and wavelength across a spectrum formed from the wavelength division optical signals. The OPM is utilized to monitor the health of the wavelength division multiplexed optical signals communicated within the telecommunications network by measuring power, center wavelength, and OSNR, for example.

There are several known implementations of an OPM. These implementations generally fall into two classes: (i) scanning, and (ii) focal plane array based OPMs. The principles of the present invention are directed to the latter class of OPMs.

A typical focal plane array based OPM includes optical components that separate the wavelength division multiplexed optical signals into its constituent monochromatic or narrowband optical signals. The optical components of the OPM generally include lenses for focusing and collimating the optical signals, a diffraction grating for separating the wavelength division multiplexed optical signals to form a spatial representation of its discrete power spectrum, and a photo-diode array that forms a pixelated optical detector or other optical detector that receives and converts the discrete power spectrum into electrical signals. The pixelated optical detector is formed as an array of multiple optical detector elements, where the multiple optical detector elements convert optical signals into electrical signals in parallel.

The OPM is ultimately used to measure the power spectrum of the narrowband optical signals. By measuring the narrowband optical signals, the health of the optical layer of the fiber optic network may be determined.

There exists four main mechanisms of a focal plane array based OPM that degrade the measurement of the power spectrum. These mechanisms include: (1) diffusion of carriers, generated by the narrowband optical signals, within the substrate of the optical detector, where carriers have long lifetimes and may travel a relatively long distance across the optical detector before recombination occurs; (2) the diode elements in the detector array being insufficiently clamped, which leads to a voltage drop between adjacent diode elements and a lateral injection of charges from one diode element to an adjacent diode element; (3) a resolution limit due to a finite aperture of an input optical fiber; and (4) aberrations of optical components of the OPM. Two mechanisms of concern are the first two above-described mechanisms (i.e., the diffusion and lateral injection of carriers). These two mechanisms are induced by the optical detector and inflate the noise floor. The noise floor, being spatially varying, degrades metrics, such as optical signal-to-noise ratio and center wavelength measurements.

### SUMMARY OF THE INVENTION

To overcome the measurement problems of the focal plane array based OPM induced by the optical detector, including: (i) reduced measurement range of an optical signal-to-noise ratio (OSNR), and (ii) reduced crosstalk between channels when neighboring channels have disparate powers, deconvolution may be used to compensate for a component of a point spread function of the optical detector. The deconvolution process utilizes a filter to substantially compensate for a component of the point spread function of the optical detector, where the filter is generated by performing an initial calibration of an optical performance monitor (OPM) using a known optical signal to obtain a measured response of the known signal. An example of a calibration source is a monochromatic optical signal having a Gaussian intensity profile at the detector. The differences between the measured (i.e., actual) and expected detector response may be used to calculate the point spread function of the optical detector and form the filter. The filter may thereafter be utilized during the operation of the OPM to increase the measurement range of the OSNR or other characteristics of an optical signal.

One embodiment of the principles of the present invention includes a method and device for improving a signal-to-noise ratio measurement range of a monitoring device operating on a fiber optic network. The embodiment includes receiving a wavelength division multiplexed optical signal including a plurality of optical signals centered at different wavelengths within a range of wavelengths. Further, the embodiment includes dispersing the wavelength division multiplexed optical signal to form a discrete power spectrum (i.e., a plurality of optical signals). The discrete power spectrum is measured by a pixelated optical detector and data representing the measured optical signals is generated. The measured optical signals include a point spread function response of the pixelated optical detector. A deconvolution operation is performed on the generated data to create data that is more representative of the discrete power spectrum by compensating for the point spread function of the pixelated optical detector. By compensating for the point spread function of the pixelated optical detector, an improved signal-to-noise ratio measurement range of the monitoring device is obtained.

Another embodiment, according to the principles of the present invention, includes a method for calibrating an optical performance monitor to improve a signal-to-noise ratio measurement range of the optical performance monitor. The method includes measuring a known calibration optical signal and generating data representative thereof. The generated data is transformed into the frequency domain. A frequency response of expected data of the known optical signal may be calculated or loaded and a filter based on the measured data and the expected data is generated. The filter may be stored and subsequently utilized in a deconvolution operation to improve the signal-to-noise ratio measurement range of the optical performance monitor.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a representative fiber optic network having an optical performance monitor according to the principles of the present invention;

FIG. 2 is a block diagram of the optical performance monitor according to FIG. 1;

FIG. 3 is an exemplary graph of a measured versus expected response to a known optical signal having a Gaussian beam profile by the optical performance monitor according to FIG. 2;

FIG. 4A is an exemplary transfer function block diagram representation for performing a convolution operation as is inherent to the optical performance monitor of FIG. 2;

FIG. 4B is an exemplary transfer function block diagram representation for performing a deconvolution operation according to the principles of the present invention and operable within the optical performance monitor of FIG. 2;

FIG. 5 is an exemplary flow diagram for calibrating the optical performance monitor according to FIG. 2;

FIG. 6 is an exemplary signal processing block diagram for the deconvolution operation performed within the optical performance monitor of FIG. 2; and

FIG. 7 is an exemplary graph of an uncorrected curve versus a deconvolution corrected curve as produced by the optical performance monitor of FIG. 2.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Operators of optical networks desire the ability to monitor performance of optical signals across the optical networks. By monitoring certain signal parameters describing the performance of the signals on the optical network, an operator can readily identify minor or major problems occurring within the optical networks. One signal parameter used to monitor the performance of an optical layer of an optical network is an optical signal-to-noise ratio (OSNR). The OSNR provides the ability to monitor the optical network in such a way as to determine if degradation or malfunction has occurred in the optical layer. However, the OSNR parameter of the optical signals themselves may be difficult to accurately calculate as a true noise floor (for the signals being measured) is often degraded by operating characteristics of the optical detector measuring the signals, as explained above.

According to the principles of the present invention, the capability of a pixelated detector based spectrometer to accurately measure the OSNR or other characteristics of an optical signal may be improved by using a deconvolution operation to process measured optical signals. As is well understood in the art, convolution in the spatial domain may be performed by multiplication in the frequency domain, while deconvolution in the spatial domain may be performed by division in the frequency domain. An actual response or measurement produced by the optical detector and a theoretical or expected response thereof may be used to calculate a transfer function mathematically describing the optical detector, where the transfer function is substantially representative of the point spread function of the optical detector. The transfer function of the optical detector is used as a filter during the deconvolution operation to compensate the point spread function induced by the optical detector. The deconvolution process, in this way, improves the optical signal-to-noise ratio measurement range of the optical performance monitor.

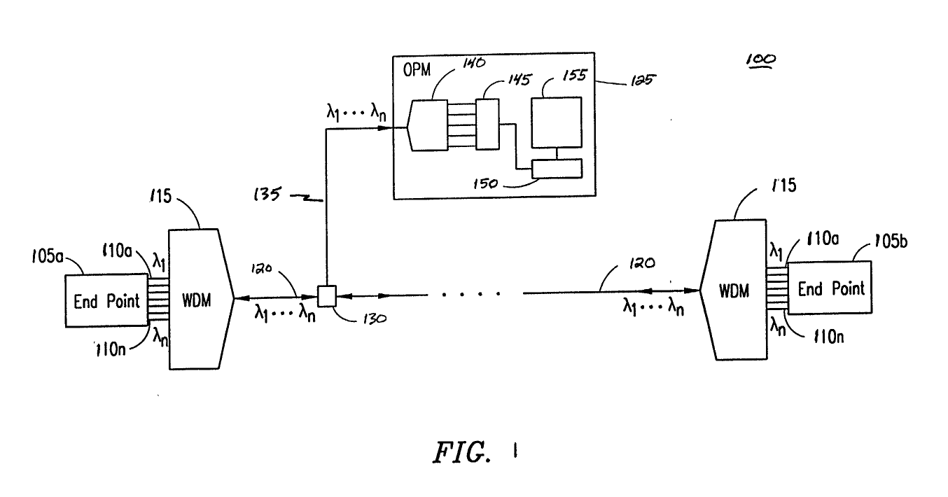

FIG. 1 shows a block diagram of an exemplary optical network 100. The exemplary optical network 100 includes two end points 105a and 105b. The two end points represent, possibly, two different cities that are in fiber optic communication. At each city, a network operator maintains fiber optic network equipment. At each end point 105a and 105b, a plurality of fiber optic lines 110a, 110b, . . . , 110n, carry narrowband optical signals having center wavelengths ranging from λ₁, X₂, . . . , λₙ (i.e., λ₁-λₙ, referred to hereafter as narrowband optical signals). The narrowband optical signals λ₁-λₙ may range over at least the optical C-band (approximately 1520 nm to approximately 1566 nm), L-band (approximately 1560 nm to approximately 1610 nm), and/or S-band. Each narrowband optical signal λ₁-λₙ is a time division multiplexed optical signal and is wavelength division multiplexed with the other narrowband optical signals by a wavelength division multiplexer/demultiplexer 115. The multiplexed narrowband optical signals λ₁-λₙ are inserted into the fiber optic line 120.

An optical performance monitor 125 measures the narrowband optical signals λ₁-λₙ via an optical splitter 130 by extracting and routing a percentage of the power of the multiplexed optical signal to an input fiber optic line 135. The optical performance monitor 125 receives the multiplexed optical signal from the input fiber optic line 135.

The optical performance monitor 125 includes a pixelated optical detector based spectrometer 140, electronics 145, processing unit 150, and a device 155 for communicating or displaying measurements. The spectrometer 140 spatially disperses the multiplexed optical signal onto a pixelated optical detector within spectrometer 140. The pixelated optical detector may be indium gallium arsenide (InGaAs). Other materials for the pixelated optical detector may be utilized. It should be understood that the principles of the present invention are not dependent upon the particular optical components of the optical performance monitor 125.

The optical detector array converts the narrowband optical signals into electrical signals in parallel. The electronics 145 prepare the measurements for a processing unit 150. The processing unit 150 includes a processor, such as a general processor or a digital signal processor (DSP), that performs the deconvolution operation, optical signal-to-noise computations, and other monitoring calculations.

The device 155 included as part of the OPM 125 may either be a communication device (e.g., modem, line driver, optical driver, transmitter) or a display device (e.g., monitor) to communicate or display, respectively, the results of the calculations performed by the processing unit 150. If the device 155 communicates the results, such communication may be via a network, such as the Internet, the optical network 100, a local area network, or cable connected directly to a display device.

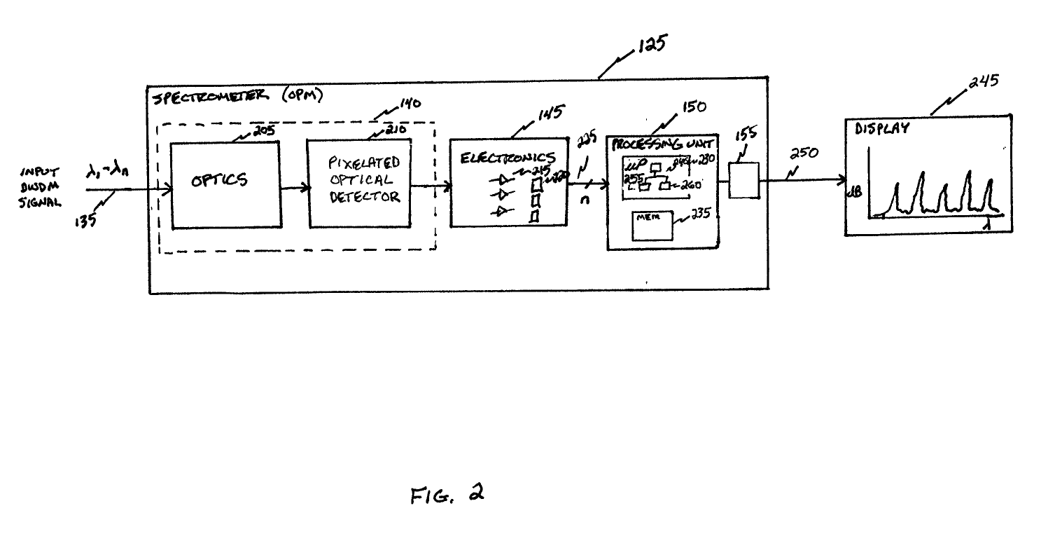

FIG. 2 is a more detailed block diagram of the optical performance monitor 125, showing the spectrometer 140, electronics 145, and processing unit 150. The spectrometer 140 includes optics 205 and a pixelated optical detector 210. The optics 205 includes an input port (not shown) coupled to the input fiber optic line 135 carrying the wavelength division multiplexed optical signal having center wavelengths λ₁-λₙ. The optics 205 may include a diffraction grating (not shown) to disperse the wavelength division multiplexed optical signal received from the input fiber optic line 135. Other optical components may also be included in the optics 205 to image the narrowband optical signals λ₁-λₙ onto the pixelated optical detector 210. The pixelated optical detector 210 is comprised of a plurality of substantially independent detector elements or pixels, where the individual pixels convert, in parallel, a component of the imaged discrete power spectrum of the wavelength division multiplexed signal into electrical signals.

The electronics 145 are electrically connected between the pixelated optical detector 210 and the processing unit 150. The electronics 145 may include conditioning circuits (e.g., linear amplifiers) 215 and analog-to-digital (A/D) converters 220 to convert the pixelated optical detector 210 output to a digital signal. The output of the electronics 145 may include one or more serial or parallel buses 225 connected to the processing unit 150.

The processing unit 150 includes a processor 230 and a memory 235 coupled thereto. The processor 230 operates a software program 240 that processes the data received from the electronics 145. The data and the software program 240 may be stored in the memory 235 and be utilized during operation of the OPM 125. The processing unit 150 is coupled to an external display device 245 via the device 155 and bus 250, where the bus 250 may be serial or parallel.

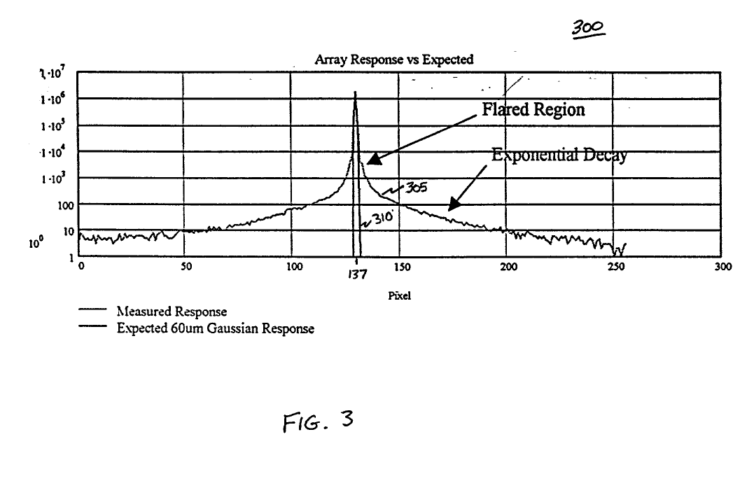

The data applied to the processor 230 is considered to be raw data (i.e., no signal processing has yet been performed on the data). The processor 230 executes the software program 240 that performs the signal processing on the raw data. A deconvolution routine 255 deconvolves the raw data utilizing a filter to generate corrected data. The deconvolution routine is described in greater detail below with regard to FIG. 3.

With further reference to FIG. 2, the corrected data may then be utilized by other software routines 260 for performing specific channel measurements, such as computing optical signal-to-noise ratio or center wavelength. The channel measurements may thereafter be communicated via the bus 250 to the display device 245 for presentation of power versus wavelength and/or pixel, for example, to the operator of the optical network. Although not shown in detail, it should be understood that the processing unit 150 includes additional circuitry, such as receivers and transmitters (e.g., line drivers), memory, and other typical processing hardware and software for performing the signal processing operations.

FIG. 3 is an exemplary graph 300 of a measured 305 versus an expected 310 response to a calibration optical signal having a known profile (e.g., Gaussian beam) by the optical performance monitor 125. The measured optical signal 305 shows a broadening effect or “flared” region due to, for example, diffusion of carriers in the pixelated optical detector 210. The broadening effect is consistent with an exponential decay process, which may be due to long carrier lifetime in the detector substrate. The broadening effect may also be due to secondary carrier diffusion effects whose characteristic lengths are much less than that of the broader diffusion characteristic lengths. The secondary effects may be other diffusion effects in the InGaAs pixelated optical detector or neighboring pixel charge injection due to lateral drift fields between pixels. While it is difficult to precisely determine the causes of the flared and exponential decay regions of the measured signal 305, it is possible to determine the differences between the expected 310 and the measured 305 signals.

A filter may be calculated to compensate for the broadening effects caused by the pixelated optical detector 210. By compensating for the broadening effects, the narrowband optical signal may be more accurately measured (i.e., the measurement range may be improved) and displayed.

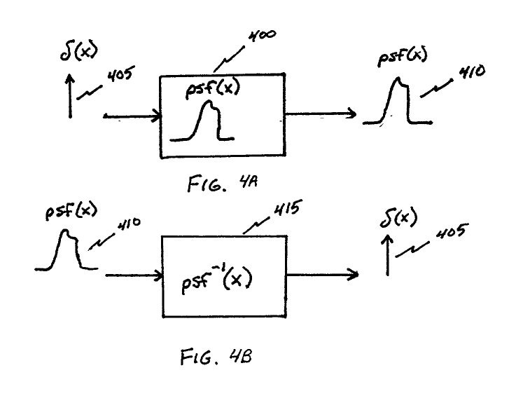

The filter may be better understood by reviewing the basics of transfer functions as applied to convolution and deconvolution operations. FIG. 4A is an exemplary transfer function block diagram representation for performing a convolution operation as is inherent to the optical performance monitor 125 due to the point spread function of the optical detector. The deconvolution based approach for improving the optical signal-to-noise ratio measurement range of the optical performance monitor 125 is fundamentally based on the principles of convolution and deconvolution.

The convolution operation assumes that the signal appearing on the input fiber optic line 135 is convolved by a filter or point spread function that behaves as a low pass filter. The effect of the point spread function on the signal is to broaden the measured signal as described above and illustrated in FIG. 3. Shown in FIG. 4A, if a delta function 405 is input to a system described by point spread function 400, the resulting output 410 is the point spread function 400 itself. Correlating the point spread function 400 to the spectrometer 140, the point spread function 400 represents the response of the pixelated optical detector 210 (assuming that the measurement range of the pixelated optical detector is limited by the point spread function). It should be understood that a point spread function describing the optics 205 and the pixelated optical detector 210 may additionally be utilized. However, the principles of the present invention are directed to correction of the point spread function of the pixelated optical detector 210.

FIG. 4B is an exemplary transfer function block diagram representation for performing a deconvolution operation according to the principles of the present invention and executed within the optical performance monitor 125. A filter 415 having a transfer function being an inverse point spread function (i.e., psf⁻¹(x)) may be generated, such that when the resulting output 410 (created by convolving the delta function 405 with the point spread function 400 in FIG. 4A) is deconvolved with the filter 415, the delta function 405 results. In other words, in a linear system, the effects of the point spread function under a convolution operation are substantially canceled. In practice, however, deconvolution cannot exactly reconstruct the data due to noise of measurements, quantization error, bandwidth limitations, etc. Therefore, compensation for the point spread function of the pixelated optical detector 210 may be performed, but complete cancellation may not be possible.

Practically speaking, implementation of the deconvolution operation includes the fast Fourier transform (FFT), which transforms a signal from the spatial domain to the frequency domain. The FFT is used because of computational efficiency as well as the property that convolution in the spatial domain is performed as multiplication in the frequency domain. The method for generating a filter, which, in effect, calibrates the optical performance monitor 135, for use in performing the deconvolution operation is:

1. Measure at least one known calibration optical signal (i.e., an actual spot f(x) on the pixelated optical detector).

2. Perform the FFT to transform the measured spot f(x) from the spatial domain to the frequency domain F(υ).

3. Divide F(υ) by the spectrum of the expected Gaussian spot, G(υ), to obtain filter H(υ) (i.e., H(υ)=F(υ)/G(υ)).

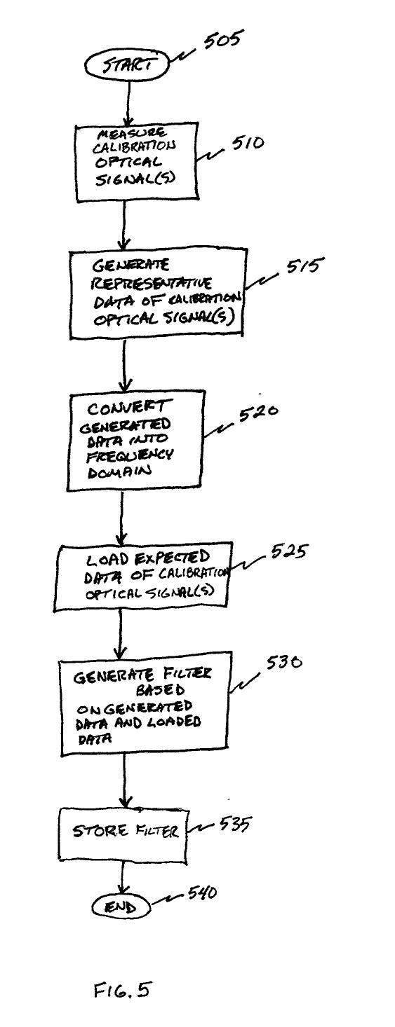

Relatedly, FIG. 5 is an exemplary flow diagram 500 for calibrating the optical performance monitor 125 according to the principles of the present invention. The process starts at step 505. At step 510, at least one known calibration optical signal is measured by the pixelated optical detector 210. If multiple calibration optical signals are used, the known calibration optical signal(s) may be measured simultaneously or at distinct times. The spatial mode of a single mode optical fiber has a near Gaussian profile, which simplifies the calculation of the expected detector response. It should be understood that the measurement of the known calibration optical signal(s) may occur within the OPM 125 or may be measured using the detector 215 without other components (i.e., the fiber carrying the known calibration signal may be imaged directly on detector 215).

The expected detector response is based on a known characteristic of the input spot imaged on the pixelated detector. The known characteristic includes a parameter, a spot waist (e.g., 1/e²), which is measured from the raw data. The reason for measuring the spot waist parameter is due to variability of the optics. The variability in the optics of the OPM leads to different spot sizes in the focal plane. The spot waist may be measured from the raw data when the spot is centered on a pixel because the diffusion term is at a lower amplitude. Thus, the theoretical expected response of the pixelated optical detector may be based on the measured data such that the effects of the optics are not corrected in the deconvolution operation, but the effects of the pixelated optical detector are corrected in the deconvolution operation.

With the wavelength adjusted such that the centroid of the spot is substantially centered on a pixel, a response from the pixel with the adjacent two pixels may be used to fit an integrated gaussian profile g(x) to the raw data. The integrated Gaussian g(x) is the expected detector response. Since the difference between the response of the detector to the exact spatial mode propagating in the fiber, such as SMF-28, and a best-fit Gaussian profile are negligible to 60 dB below the peak, the Gaussian provides a very good approximation.

At step 515, raw calibration data of the measured known calibration optical signal(s) is generated by the pixelated optical detector 210. In generating the raw calibration data, the measured calibration optical signal(s) may be amplified, digitized, and scaled, for example, by electronics 145. The raw calibration data is transformed into the frequency domain by processing unit 150 at step 520. The conversion may be performed using the FFT technique or any other linear transform, such as the Laplace transform, that transforms data to the frequency domain.

At step 525, expected data of the known calibration optical signal(s) may be loaded or generated. The expected data may be generated via a mathematical model describing an integrated optical signal having an expected beam profile (e.g., Gaussian profile). A filter based on the transformed raw calibration data and the loaded/generated expected data is calculated at step 530. The filter is generated in the frequency domain by dividing the measured by the expected data in the frequency domain (e.g., H(υ)=F(υ)/G(υ)). While the filter may be alternatively generated in the spatial domain, computational efficiency is greatly increased in the frequency domain. The filter is stored in either the spatial or frequency domain at step 535, and the filter generation process ends at step 540. It should be noted that for arrays with point spread functions that vary with temperature, filters may be generated at fixed temperatures and selected accordingly during normal operation of the OPM 125.

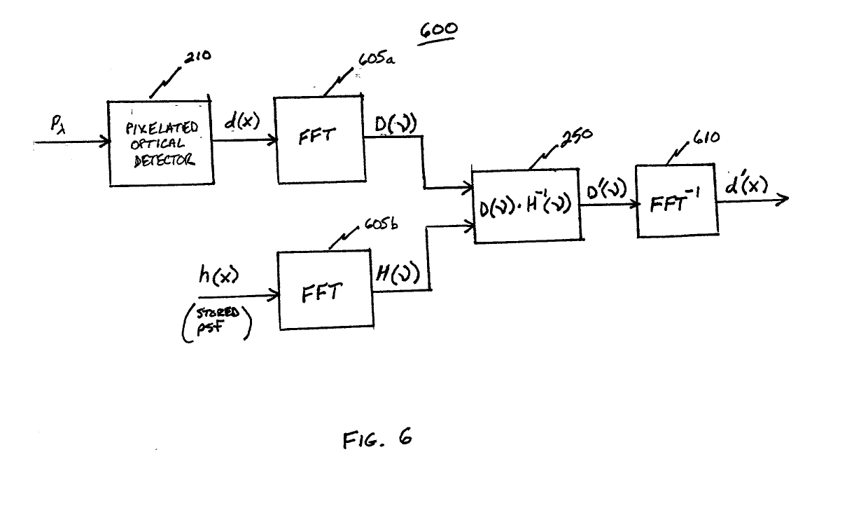

FIG. 6 is an exemplary signal processing flow diagram 600 for performing the deconvolution process within the OPM 125 on the measured data signal d(x) according to the principles of the present invention. A narrowband or arbitrary optical signal P_{λ} is received by the pixelated optical detector 210 and converted from an optical signal to an electrical signal. The electrical signal may be amplified and digitized by the electronics 145 and received by the processing unit 150 as a measured signal d(x) in the spatial domain. A fast Fourier transform 605a transforms the measured signal d(x) into a measured signal D(υ) in the frequency domain.

A point spread function h(x) of the pixelated optical detector stored in the spatial domain (see FIG. 5) is transformed to the filter H(υ) in the frequency domain by a fast Fourier transform 605b. The point spread function h(x), alternatively, may be stored in the frequency domain (i.e., H(υ)) to avoid additional processing during run-time. Both the measured signal D(υ) and the filter H(υ) are received by the deconvolution routine 255, which deconvolves the measured signal D(υ) by dividing (i.e., multiplying by the inverse) the measured signal D(υ) by the filter H(υ). The result of the deconvolution is a compensated measured signal D′ (υ) in the frequency domain. The compensated measured signal D′ (υ) is processed by an inverse fast Fourier transform 610 to transform the compensated measured signal D′ (υ) in the frequency domain into a compensated measured signal d′ (x) in the spatial domain. The compensated measured signal d′ (x) replaces d(x) in subsequent calculations.

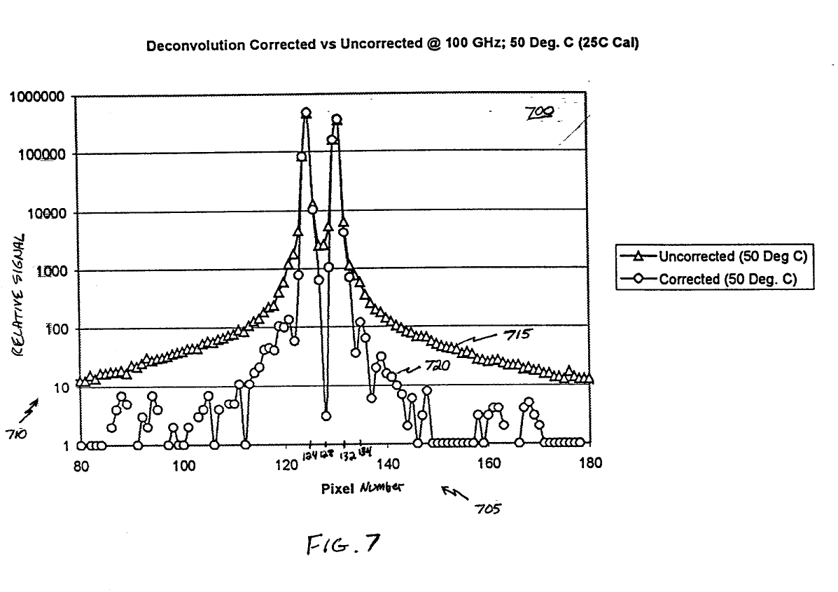

FIG. 7 is an exemplary graph of an uncorrected curve (i.e., raw data) versus a corrected curve (i.e., compensated data) as produced by the optical performance monitor 125 performing the deconvolution operation. The x- and y-axes of the graph include pixel number 705 and relative signal 710, respectively. The pixel number 705 refers to a pixel or detector element along the pixelated optical detector 210 and the relative signal count 710 refers to a relative integrated signal at each pixel after processing by the electronics 145.

The uncorrected 715 and corrected 720 curves are formed from two carrier wavelengths produced by two lasers spaced 100 GHz apart. As shown, one carrier wavelength is located at pixel number 125, and a second carrier wavelength is located at pixel number 131. Both the uncorrected 715 and corrected 720 curves have the same integration. A local minimum located between the carrier wavelengths is located at pixel number 128.

Further with reference to FIG. 7, the corrected curve 720 has a significantly lower measured value (i.e., below ten) at pixel number 128 than does the uncorrected curve (i.e., about 2000). The difference between the corrected 720 and the uncorrected 715 curves at pixel number 128 suggests that the point spread function due to carrier wavelengths located 100 GHz apart significantly affects the noise floor measurement between the carrier wavelengths. The data, as presented, shows that the point spread function may be compensated effectively by utilizing deconvolution techniques according to the principles of the present invention.

The previous description is of a preferred embodiment for implementing the invention, and the scope of the invention should not necessarily be limited by this description. The scope of the present invention is instead defined by the following claims.

What is claimed is:

1. A monitoring device operating on a fiber optic network, the monitoring device comprising:
an input port for receiving a wavelength division multiplexed optical signal including a plurality of optical signals centered at different wavelengths within a range of wavelengths;
a dispersion device disposed to disperse the wavelength division multiplexed optical signal into a discrete power spectrum;
a pixelated optical detector having a point spread function and optically coupled to receive and convert the discrete power spectrum into electrical signals; and
at least one computing device receiving digital data representative of the electrical signals, performing a deconvolution operation on the digital data to compensate for the point spread function of the pixelated detector, and generating compensated output data representative of the optical signals.

2. The monitoring device according to claim 1, wherein said at least one computing device further transforms the digital data to the frequency domain.

3. The monitoring device according to claim 2, wherein the transformation includes performing a fast Fourier transform (FFT).

4. The monitoring device according to claim 2, wherein said at least one computing device utilizes a filter representative of the point spread function of said pixelated optical detector.

5. The monitoring device according to claim 4, wherein the filter is utilized during the deconvolution operation.

6. The monitoring device according to claim 1, wherein said at least one computing device further transforms the compensated output domain to the spatial domain.

7. The monitoring device according to claim 1, further comprising at least one of the following:
a display coupled to said at least one computing device for displaying the compensated output data,
a communication device coupled to said at least one computing device for transmitting the compensated output data.

8. The monitoring device according to claim 1, wherein the wavelength range of the wavelength divisional multiple optical signal includes at least one of the following:
the optical L-band,
the optical C-band, and
the optical S-band.

9. A method for improving a signal-to-noise ratio measurement range of a monitoring device operating on a fiber optic network, the method comprising:
receiving a wavelength division multiplexed optical signal including a plurality of optical signals centered at different wavelengths within a range of wavelengths;
dispersing the wavelength division multiplexed optical signal into a discrete power spectrum;
measuring the discrete power spectrum by a pixelated optical detector, the measured optical signals including a point spread function response of the pixelated optical detector;
generating data representing the measured optical signals;
performing a deconvolution operation on the generated data to compensate for the point spread function of the pixelated optical detector; and
generating compensated output data representative of the optical signals.

10. The method according to claim 9, further comprising:
transforming the generated data to the frequency domain prior to performing the deconvolution operation.

11. The method according to claim 10, wherein said transforming includes performing a fast Fourier transform (FFT) on the generated data.

12. The method according to claim 9, further comprising:
measuring a known calibration optical signal by the pixelated optical detector; and
generating a filter based upon the measured known calibration optical signal, wherein performing the deconvolution operation utilizes the filter to compensate for the point spread function of the pixelated optical detector.

13. The method according to claim 12, wherein the known calibration optical signal has a substantially Gaussian beam profile.

14. The method according to claim 12, wherein the filter is utilized during the deconvolution operation in the frequency domain.

15. The method according to claim 9, further comprising:
determining a current operating temperature of the pixelated optical detector; and
loading a filter generated at an operating temperature closest to the current operating temperature.

16. The method according to claim 9, wherein the deconvolution operation further includes filtering the generated data to compute the compensated output data in the frequency domain.

17. The method according to claim 16, further comprising transforming the compensated output data to the spatial domain.

18. The method according to claim 17, wherein the transforming includes performing an inverse fast Fourier transform (IFFT).

19. The method according to claim 9, further comprising displaying the compensated output data representative of the discrete power spectrum.

20. The method according to claim 9, wherein the wavelength range includes at least one of the following:
the optical L-band,
the optical C-band, and
the optical S-band.

21. A method for calibrating an optical performance monitor having a pixelated optical detector for improving an optical signal-to-noise ratio measurement range of the optical performance monitor, the method comprising:
measuring a known calibration optical signal applied to the pixelated optical detector;
generating data representative of the measured known calibration optical signal;
transforming the generated data into the frequency domain;
loading data representative of expected data of the known calibration optical signal in the frequency domain; and
generating a filter in the frequency domain based on the generated and expected data, the filter being utilized to improve the signal-to-noise ratio measurement range of the optical performance monitor.

22. The method according to claim 21, further comprising storing the filter.

23. The method according to claim 21, wherein the known calibration optical signal has a substantially Gaussian beam profile.

24. The method according to claim 21, wherein the known calibration optical signal is a plurality of calibration optical signals, each calibration optical signal being measured simultaneously.

25. The method according to claim 21, further comprising:
adjusting an operating temperature of the pixelated optical detector of the optical performance monitor prior to measuring the known optical signal; and
storing the generated filter using the generated data at the adjusted operating temperature.

26. A computer-readable medium having stored thereon sequences of instructions, the sequences of instructions including instructions, when executed by a processor of an optical performance monitor, causes the processor to:
load filter data representative of differences between a known calibration optical signal and an expected measurement of the known calibration optical signal;
receive measured data representative of at least one optical signal from a pixelated optical detector;
deconvolve the measured data utilizing the loaded filter data to produce corrected data; and
output the corrected data.

27. The computer-readable medium according to claim 26, wherein the known calibration optical signal has a substantially Gaussian beam profile.

28. The computer-readable medium according to claim 26, wherein the instructions to deconvolve include dividing the measured data with the filter data in the frequency domain.
